(19) United States
(12) Patent Application Publication
(10) Pub. No.: US 2020/0099068 A1
(43) Pub. Date: Mar. 26, 2020

(54) PROCESSES FOR LASER JOINING ELECTROCHEMICAL CELL MEMBERS

(71) Applicant: Na4B, LLC, Rochester Hills, MI (US)

(72) Inventors: Monika Jansohn, Rochester Hills, MI (US); Cord-Henrich Dustmann, Sagno (CH); Wolfgang Jansohn, Rochester Hills, MI (US)

(21) Appl. No.: 16/138,443

(22) Filed: Sep. 21, 2018

(51) Int. Cl. H01M 8/0297; H01M 2/14; H01M 8/0202

(52) U.S. Cl. CPC H01M 8/0297; H01M 2250/20; H01M 8/0269; H01M 2/145

(57) ABSTRACT

A method to join electrochemical cell members comprising an inorganic material by laser. The method includes the steps of positioning the electrochemical cell members to each other, defining the constituents of the joining process, utilizing a laser system to generate a laser beam, focusing the laser beam spot on the electrochemical cell members, and establishing the joint by producing joint segments in a defined joining sequence. The joining method allows to produce gastight, high-temperature resistant connections between electrochemical cell members.

### FIELD OF TECHNOLOGY

The instant disclosure is related to electrochemical cell members and particularly laser joining of electrochemical cell members.

### BACKGROUND

The expected transition from today's fossil fuel based economy to a renewable energy based economy has led to an increased interest in developing new concepts and chemistries for electrochemical cells.

Electrochemical cells in batteries and fuel cells are considered to provide the needed energy storage to mitigate the fluctuating renewable energy production from solar and wind. A wide spread introduction of electric vehicles requires improved electrochemical cells with a high energy density, for long driving range, as well as a high power density, to fast accelerate and to climb grades.

In all cases robust and safe electrochemical cells having a high calendar life and a high cycle life are required. In particular, the design of electrochemical cells should not rely on flammable materials, e.g. polymeric separators or flammable electrolytes. For example, inorganic, non-flammable solid electrolytes are a preferable technical solution to separate and electronically insulate the electrodes while also providing a high ionic conductivity. The strong temperature dependence of the resistivity of inorganic materials often requires to operate the electrochemical cells at high temperatures, e.g. the operating temperature range for sodium nickel-chloride electrochemical cells is 270° C. to 350° C., for sodium sulfur electrochemical cells is 300° C. to 400° C. and for solid oxide fuels cells (SOFC) 800° C. to 1000° C.

A common electrochemical cell design with a solid electrolyte separating the compartment of the negative and the positive electrode includes an electrically non-conductive member. The non-conductive member is disposed between the solid electrolyte, housing of the negative electrode, and housing of the positive electrode, whereby the positive and negative electrode housings are electrically separated, limiting any material exchange and electrical current between the electrodes to the ionic current through the solid electrolyte.

The electrochemical cell design requires a gastight, high temperature resistant connection between the solid electrolyte and the electrically non-conductive member. Glass sealing is the most prevalent technology to form this connection in batteries, e.g. sodium sulfur batteries. The glass is applied at the joint between the solid electrolyte and the electrically non-conductive member and subsequently heat treated in an oven, preferably at a temperature between 800° C. and 1000° C. The molten glass wets the joint surfaces and forms the gastight connection.

A drawback of the glass sealing is that the production process is demanding, time consuming and cost intensive, caused among others things by the energy consumption of the heat treatment process.

Another drawback of the glass sealing in SOFCs is the formation of pores during a continued exposure of the glass seal to temperatures above 800° C. The formed pores make the glass seal susceptible to micro cracking during thermal cycles. Hence, glass seals are preferably employed in tubular SOFCs, where the connection between the solid electrolyte and the electrically non-conductive member can be established outside of the high temperature area.

Therefore, current SOFCs based on planar electrochemical cells are mainly built as mechanically tightened fuel cell stack assemblies, wherein the connection between the solid electrolyte and the electrically non-conductive member is sealed by a compressive mica-based seal.

However, a drawback of mica-based compressive seals in planar electrochemical cells are their high leak rates and their short life time due to cracking.

Despite the many advantages of planar solid electrolyte and electrochemical cell designs in cell component production, cell assembly, as well as in SOFC or battery assembly, the challenges in component joining and sealing prevent their wide spread application. Hence the tubular or test-tube shaped solid electrolyte is still the more prevalent design employed in high temperature electrochemical cells.

In view of the above, an improved joining method to connect electrochemical cell members made from inorganic materials would be desirable.

### Notations

“Joint surfaces” as used herein are surfaces of parts to be joined that realize local holding or joining together after a connection or joint has been produced.

“Heat-affected zone” as used herein is the region of the parts to be joined adjacent to a joint which is not melted and has altered microstructure due to applied process heat, e.g. from heat flow into the material from laser joining or laser cutting operation.

“Joint stitch line” as used herein is a joint line or path where a joint is to be made or has been made from two or more joint segments joined together, e.g. by overlapping each other (stitching).

“Cut stitch line” as used herein is a cut line or path where a cut is to be made or has been made in an electrochemical cell member.

“Laser cut” as used herein is a cut (gap) formed in an electrochemical cell member by a laser.

“Wall plug efficiency” as used herein is the energy conversion efficiency a laser system with which the laser system converts electrical power into optical power.

“Connection” as used herein is a seal or joint between a first electrochemical cell member and a second electrochemical cell member.

### SUMMARY OF THE DISCLOSURE

It is an object of the disclosure to provide a method for joining electrochemical cell members comprising an inorganic material.

Another object of the disclosure is to provide a method for joining electrochemical cell members comprising an inorganic material, the method producing a gastight, high-temperature resistant connection between said electrochemical cell members.

Another object of the disclosure is to provide a method for joining electrochemical cell members comprising an inorganic material, where the applied joining and sealing technology allows the design of flat electrochemical cells in applications currently dominated by tubular or test-tube shaped electrochemical cell designs.

Another object of the disclosure is to provide a high productive and low cost method for joining electrochemical cell members comprising an inorganic material by applying a laser joining process.

In embodiments, a method for laser joining a first electrochemical cell member to a second electrochemical cell member is provided. The method includes providing the first electrochemical cell member made from an inorganic material, the first electrochemical cell member having a first thickness and a first joint surface. The second electrochemical cell member made from an inorganic material is provided and has a second thickness and a second joint surface. The process includes defining the placement of at least two joint segments, each joint segment having a joint segment length, a joint segment width and a joint segment line extending along the joint segment length and generally in the middle of the joint segment width. The placement of a joint made from the at least two joint segments, with adjacent joint segments in contact to each other is also defined, as is a joint sequence and a joint stitch line made by the joint segment lines assembled in the joint sequence. Contact between the first joint surface and the second joint surface is established by positioning the first electrochemical cell member and the second electrochemical cell member relative to each other. A laser beam is produced using a laser system, the laser beam having a laser beam spot focused on the joint stitch line. The laser beam spot is passed along the joint stitch line to establish the at least two or more joint segments such that the at least two or more joint segments form a seal between the first electrochemical cell member and the second electrochemical cell member.

In other embodiments, a method for laser joining electrochemical cell members together is provided. The method includes providing a first electrochemical cell member, a second electrochemical cell member and a third electrochemical cell member. The first electrochemical cell member is made from an inorganic material and has a first thickness and a first joint surface. The second electrochemical cell member is made from an inorganic material and has a second thickness and a pair of second joint surfaces. The third electrochemical cell member is made from an inorganic material and has a third thickness and a third joint surface. The method includes defining a placement or location of at least two joint segments, each joint segment having a joint segment length, a joint segment width and a joining segment line extending alone the joint segment length and located generally in the middle of the joint segment width. Placement of a joint made from the at least two joint segments with adjacent joint segments in contact to each other can also be defined, as can a joint sequence and a joint stitch line to be made from the at least two joint segments assembled in the joint sequence. Contact between the first joint surface and one of the pair of second joint surfaces is established by positioning the first electrochemical cell member and the second electrochemical cell member relative to each other. Contact between the third joint surface and another of the pair of second joint surfaces is established by positioning the third electrochemical cell member and the second electrochemical cell member relative to each other. A laser beam with a laser beam spot is produced using a laser system and the laser beam spot is focused on a joint segment. The laser beam spot is passed along the joint stitch line to establish the at least two joint segments and the at least two joint segments form a connection between the first electrochemical cell member, the second electrochemical cell member and the third electrochemical cell member.

Additional features and advantages of the methods for laser joining electrochemical cells together described herein will be set forth in the detailed description which follows, and in part will be readily apparent to those skilled in the art from that description or recognized by practicing the embodiments described herein, including the detailed description which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

For a more complete understanding of the disclosure, reference is made to the following description and accompanying drawings, in which:

FIG. 1 is a flow chart illustrating an embodiment of the laser process to join electrochemical cell members;

FIG. 2A illustrates schematically an embodiment of a connection produced by a method in accordance with the present disclosure;

FIG. 2B is a cross-sectional view of section A-A in FIG. 2A;

FIG. 3A illustrates schematically another embodiment of a connection produced by a method in accordance with the present disclosure;

FIG. 3B is a cross-sectional view of section B-B in FIG. 3A;

FIG. 4A illustrates schematically a side cross-sectional view of a connection between a solid beta-alumina electrolyte and an annular alpha-alumina member applied in a sodium nickel-chloride electrochemical cell, the connection produced in an embodiment of the current disclosure;

FIG. 4B is a cross-sectional view of section A-A in FIG. 4A;

FIG. 5 illustrates schematically a prior-art connection between a solid beta-alumina electrolyte and an annular alpha-alumina member applied in a sodium nickel-chloride electrochemical cell;

FIG. 6 illustrates schematically a connection between a solid electrolyte produced from an anodic aluminum oxide membrane and an alpha-alumina frame applied in a flat sodium nickel-chloride electrochemical cell, the connection produced in an embodiment of the current disclosure;

FIG. 7 illustrates schematically a process setup to connect a solid electrolyte produced from an anodic aluminum oxide membrane to an alpha-alumina frame applied in a flat sodium nickel-chloride electrochemical cell, the process being an embodiment of the current disclosure; and

FIG. 8A illustrates schematically a process setup to connect a metal electrode enclosure to an alpha-alumina frame applied in a flat sodium nickel-chloride electrochemical cell, the process being an embodiment of the current disclosure;

FIG. 8B is a cross-sectional view of section A-A in FIG. 8A;

FIG. 9A illustrates schematically a step of a process setup to connect a metal electrode enclosure to an alpha-alumina frame applied in a flat sodium nickel-chloride electrochemical cell, the process being an embodiment of the current disclosure;

FIG. 9B illustrates schematically another step of the process setup shown in FIG. 9A to connect a metal electrode enclosure to an alpha-alumina frame applied in a flat sodium nickel-chloride electrochemical cell, the process being an embodiment of the current disclosure;

FIG. 9C illustrates schematically another step of the process setup shown in FIG. 9A to connect a metal electrode enclosure to an alpha-alumina frame applied in a flat sodium nickel-chloride electrochemical cell, the process being an embodiment of the current disclosure; and

FIG. 10 illustrates schematically a step of a process setup to connect a metal electrode enclosure to an alpha-alumina frame applied in a flat sodium nickel-chloride electrochemical cell, the process being an embodiment of the current disclosure.

### DETAILED DESCRIPTION OF THE INVENTION

In the following detailed description, reference is made to the accompanying drawings that form a part thereof, and in which is shown by way of illustration in which exemplary embodiments of the instant disclosure may be practiced. The instant disclosure is described in sufficient detail to enable those skilled in the art to practice exemplary embodiments disclosed herein and it is to be understood that other embodiments may be utilized and that changes may be made without departing from the scope of the claims. Therefore, the following description is not to be taken in a limiting sense.

This disclosure is related to a production method for connecting a first electrochemical cell member comprising an inorganic material, preferably a glass or a ceramic material, and a second electrochemical member comprising an inorganic material, preferably a glass or a ceramic material.

The first electrochemical cell member has a first thickness and a first joint surface and the second electrochemical cell member has a second thickness and a second joint surface.

The process includes the production of a complete joint established by adjacent joint segments being in contact with each other, preferably overlapping. Each joint segment has a joint segment length, a joint segment width and a joint segment line extending along the joint segment length and generally at the middle of the joint segment width. Furthermore a joint sequence is defined along a joint stitch line and a complete joint is produced by the joint segments being joined to each other and forming a continuous joint via the joint sequence.

The first joint surface and the second joint surface are positioned relative to each other in order to establish contact between the first electrochemical cell member and the second electrochemical cell member, or to establish a gap between the first electrochemical cell member and the second electrochemical cell member. In embodiments, the gap is filled with joining material.

Subsequently a laser system is utilized to produce a laser beam with the laser beam having a beam spot operable to produce a joint segment and a gas tight joint between the first electrochemical cell member and the second electrochemical cell member.

The laser beam spot is passed along a predetermined path, e.g. along a joint stitch line, to produce one or more joint segments and the joint segments form a connection between the first electrochemical cell member and the second electrochemical cell member. In embodiments, the connection between the first electrochemical cell member and the second electrochemical cell member is a seal or joint that is gas tight.

In embodiments, the laser beam may be generated as a continuous laser beam with a determined wave length and welding power, and in other embodiments the laser beam may be generated as a pulsed wave laser beam with a determined wave length and welding power. In other embodiments, the laser is operated at a wavelength selected to be substantially absorbed by the first electrochemical cell member and/or the second electrochemical cell member, or where applicable, by an additional joining material.

In embodiments, the first electrochemical cell member is laser cut prior to joining. The laser cut can be congruent with the location of one or more joint segments. The laser cut is formed by passing a laser beam spot along a predetermined oath, e.g. a cut line, joint stitch line, etc., and produces a cut or gap in the first electrochemical cell member. In embodiments, cut segments assembled in a cutting sequence are formed by the laser beam spot.

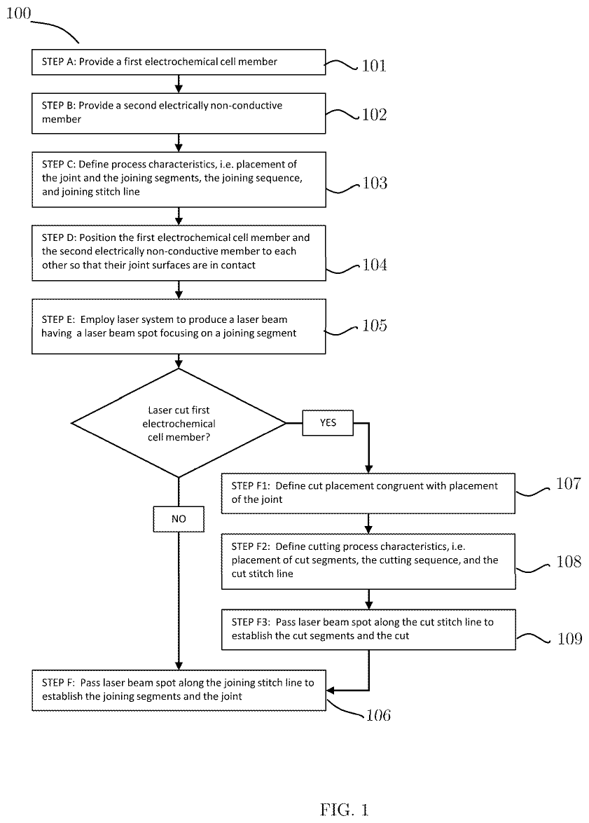

Turning now FIG. 1, a process 100 for connecting a first electrochemical cell member to a second electrochemical cell member is shown. The process 100 includes providing a first electrochemical cell member at step 101 and providing a second electrochemical cell member at step 102. The process characteristics (parameters) are defined in step 103, e.g., location of a joint stitch line, location of one or more joint segments, a joint sequence, laser power and laser beam spot velocity are defined. In step 104 the first electrochemical cell member and the second electrochemical cell member are positioned relative to each other so that their joint surfaces are in direct contact with each other, or in the alternative, so that a filler material is located between the joint surfaces. In step 105 a laser system is employed to produce a laser beam having a laser beam spot focused on the joint stitch line. In step 106 the laser beam spot passes along the joint stitch line at a predetermined velocity to establish one or more joint segments. In embodiments, the one or more joint segments form a complete joint between the first electrochemical cell member and the second electrochemical cell member. In embodiments, the complete joint is a gas tight connection (seal) between the first electrochemical cell member and the second electrochemical cell member.

It should be appreciated that protective gas or added material may or may not be used as part of the process to form joint segments between the first electrochemical cell member and the second electrochemical cell member.

As shown in FIG. 1, in embodiments, the first electrochemical cell member can be laser cut prior to joining with the second electrochemical cell member. An additional laser cutting operation can include step 107 which defines a cut location congruent with a joint segment location. Cut process parameters can be defined in step 108. The cut process parameters can include a location or path of a cut stitch line, location of at least one cut segment along the cut stitch line with adjacent cut segments in contact to each other or preferably overlapping. Each cut segment can have a cut segment length, a cut segment width and a cut segment line extending along the cut segment length and generally in the middle of the cut segment width. Furthermore the cut segment lines can be assembled together in a cutting sequence to form the cut stitch line. The laser beam spot is passed along the cut stitch line to establish the cut segments and the cut at step 109. In embodiments, the first electrochemical cell member is laser cut and a cutting edge is formed within the first electrochemical cell member. In embodiments, the second electrochemical cell member is not laser cut in step 109.

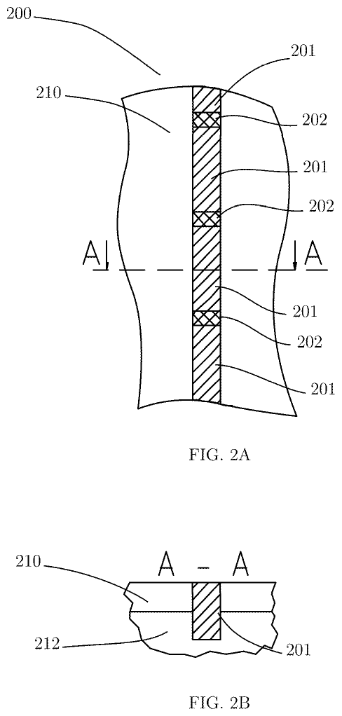

Turning now to FIGS. 2A-2B, a joint 200 produced between a first electrochemical cell member 210 and a second electrochemical cell member 212 according to an embodiment of the current disclosure is shown. Specifically, FIG. 2A shows a top view of the joint 200 formed by stitching together multiple joint segments 201 along a joint stitch line. In embodiments, each joint segment 201 overlaps with an adjacent joint segment 201. A side view of section A-A in FIG. 2A is shown in FIG. 2B and depicts a joint segment 201 extending through the first electrochemical cell member 210 and into the second electrochemical cell member 212. Adjacent joint segments 201 have a joint segment overlap 202. The joint segment overlap 202 can be between approximately 50% and 5% of the overall length of a given joint segment 201 (joint segment length). In embodiments, the joint segment overlap 202 is between 40% and 10% of the overall joint segment length, preferably between 30% and 20% of the overall joint segment length, and more preferably approximately 25% of the overall joint segment length.

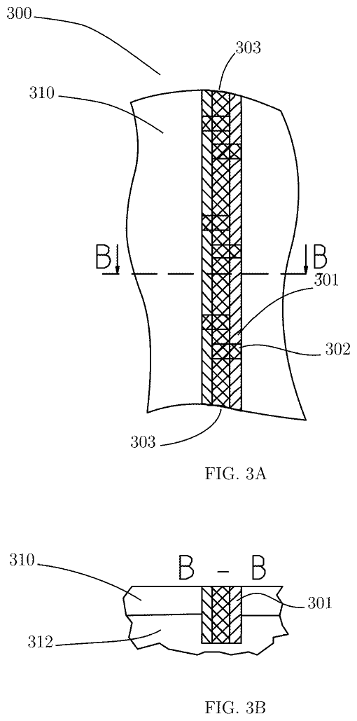

Referring now to FIGS. 3A-3B, a joint 300 produced between a first electrochemical cell member 310 and a second electrochemical cell member 312 according in an embodiment of the current disclosure is shown. Specifically, FIG. 3A shows the joint 300 formed from multiple joint segments 301 along a length of a joint stitch line, i.e. at least two joint segments 301 side-by-side each other. In embodiments, the side-by-side joint segments 301 can have an overlap region 303 along the length of each joint segment 301 (lateral joint segment overlap 303). A side view of section B-B in FIG. 3A is shown in FIG. 3B and depicts a joint segment 301 extending through the first electrochemical cell member 310 and into the second electrochemical cell member 312. Adjacent joint segments 301 have a joint segment overlap 302. The joint segment overlap 302 can be between approximately 50% and 5% of the overall length of a given joint segment 201 (joint segment length). In embodiments, the joint segment overlap 302 is between 40% and 10% of the overall joint segment length, preferably between 30% and 20% of the overall joint segment length, and more preferably approximately 25% of the overall joint segment length. The lateral joint segment overlap 303 can be between approximately 75% to 5% of the overall width of a given joint segment 301 (joint segment width). In embodiments, the lateral joint segment overlap 303 is between 70% and 10% of the overall joint segment width, preferably between 65% and 20% of the overall joint segment width, and more preferably approximately 60% of the overall joint segment width.

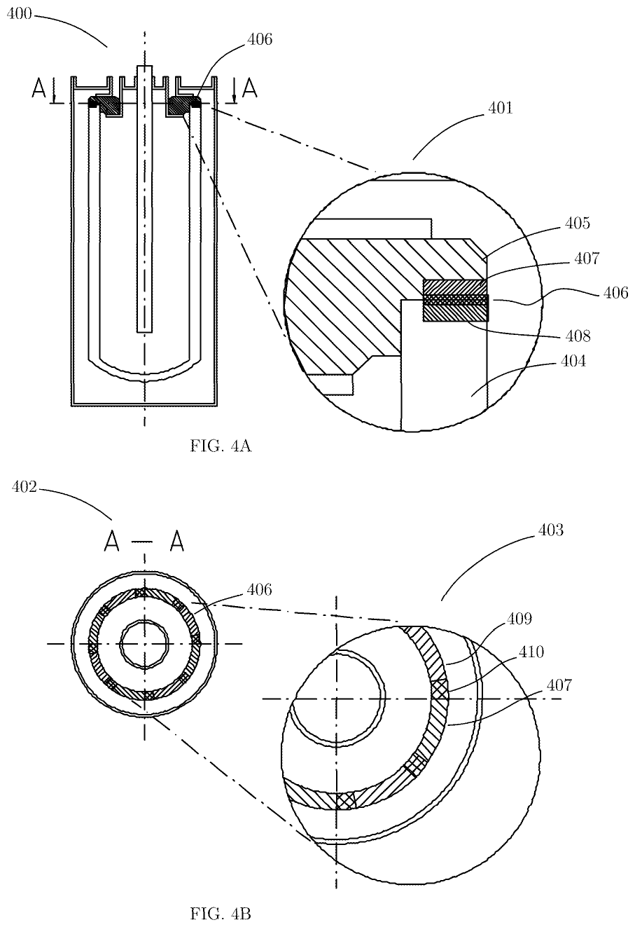

Turning now to FIGS. 4A-4B, a schematic cross section of a sodium nickel-chloride electrochemical cell 400 is shown. Specifically, a cross sectional side view with a schematic detailed section 401 of a connection between a first electrochemical cell member 404 and a second electrochemical cell member 405 is shown in FIG. 4A. In embodiments, the first electrochemical cell member 404 is a beta alumina electrolyte (beta-alumina electrolyte 404) and the second electrochemical cell member 405 is an alpha alumina member (alpha-alumina member 405). A top view of section A-A in FIG. 4A is shown at reference numeral 402 in FIG. 4B. The connection between the first electrochemical cell member 404 and the second electrochemical member 405 can be produced according in an embodiment of the current disclosure in the following steps.

The joint surface of the beta-alumina electrolyte 404 and the joint surface of the alpha-alumina member 405 are brought into contact by positioning the beta-alumina electrolyte 404 and the alpha-alumina member 405 adjacent to each other.

The connection or seal between the beta-alumina electrolyte 404 and the alpha-alumina member 405 is defined by the joint 406 being of the form shown in FIGS. 2A-2B. The schematic detailed section 401 shows a joint segment 407 in the alpha-alumina member 405 overlapped by a joint segment 408 in the beta-alumina electrolyte 404, and vice-versa. The joint 406 is formed by stitching together joint adjacent segments, e.g., adjacent joint segments 407 and 409 as shown in detailed section 403 in FIG. 4B, in a defined joining sequence. The adjacent joining segments can have an overlap portion 410. In embodiments, the overlap portion 410 is approximately 40% of the overall joint segment length.

In embodiments, the utilized laser system generates a continuous wave laser beam having an emission wavelength of 1065 nm and a welding power of approximately 400 W to 500 W. The laser beam is focused on a joint stitch line and passed with a processing velocity of approximately 50 m/min along a given joint segment. Multiple joint segments are produced to form of a continuous gastight joint between the beta-alumina electrolyte 404 and the alpha-alumina member 405 as shown in FIG. 4B.

It should be appreciated that the connection between the beta-alumina electrolyte 404 and the alpha-alumina member 405 is produced within seconds, and the process energy consumption to form the connection is in the magnitude of watt·hours, even when considering the wall plug efficiency of the laser welding system.

It should be also appreciated that the heat affected zone of a joint segment has a spatial extent in the range of millimeters and nearly the complete beta-alumina electrolyte 404 is unaffected by the joining process. In particular, the joining process does not lead to any degradation of the solid electrolyte by alkali metal loss caused by diffusion.

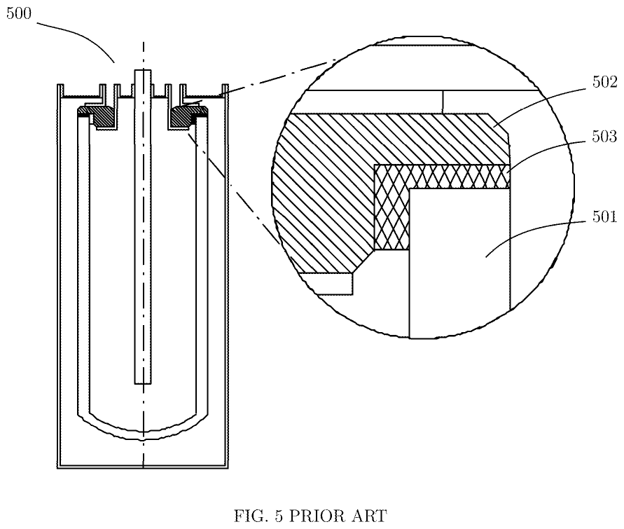

As a comparison, FIG. 5 shows a schematic cross section through a joint between a beta-alumina electrolyte 501 and an annular electrically non-conductive alpha-alumina member 502 produced with a prior art process. The connection between the beta-alumina electrolyte 501 and the alpha-alumina member 502 is produced in the following steps.

A glass seal paste 503 is applied to at least one joint surface of the beta-alumina electrolyte 501 and the alpha-alumina member 502. The joint surface of the beta-alumina electrolyte 402 and the joint surface of the alpha-alumina member 502 are positioned relative to each other with a gap of approximately 100 μm to 200 μm between the joint surfaces and the gap filled with the glass seal paste 503. The glass seal paste 503 is in contact with the joint surfaces of beta-alumina electrolyte 501 and the alpha-alumina member 502. Subsequently, the assembled beta-alumina electrolyte 501, alpha-alumina member 502 and glass seal paste 503 are heat treated for several hours in an oven, with an applied temperature profile having a maximum temperature of approximately 1000° C. A continuous gastight connection between the beta-alumina electrolyte 501 and the alpha-alumina member 502 is established.

In contrast to the present disclosure, the prior art process is a time and energy consuming production method, where the process heat required to establish the glass seal paste 503 connection is applied non-selectively to the assembly that includes the beta-alumina electrolyte 501, alpha-alumina member 502 and glass seal paste 503. For thin solid electrolytes, the applied temperature of approximately 1000° C. required in the glass seal joining process may lead to a solid electrolyte degradation caused by a diffusion driven alkali-metal loss.

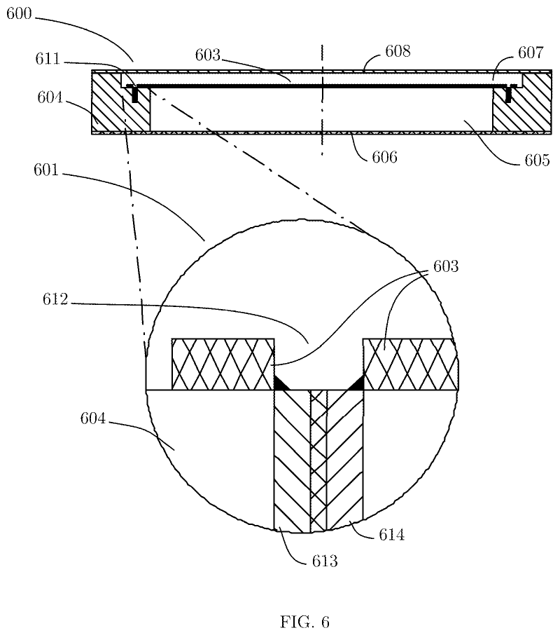

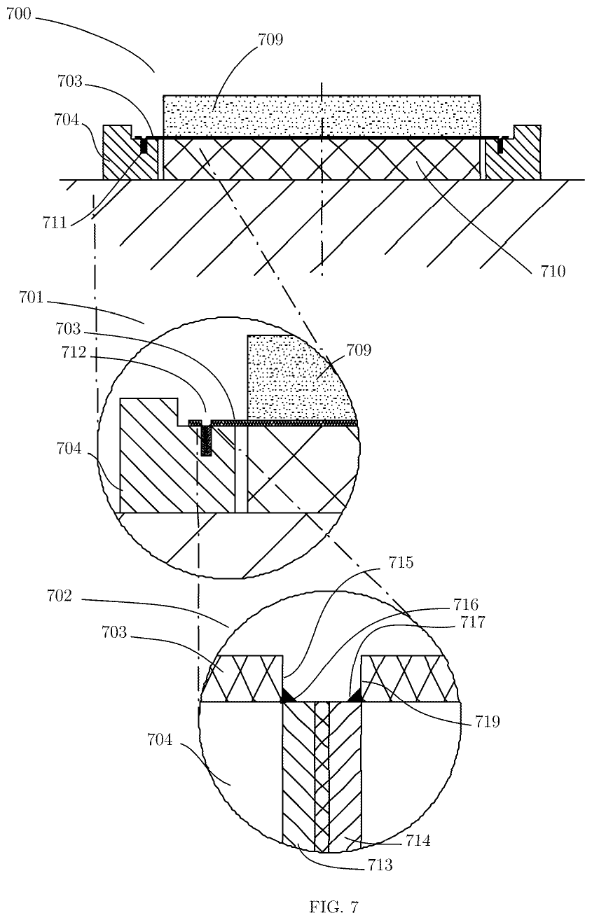

Referring now to FIG. 6, a schematic cross section through a flat sodium nickel-chloride electrochemical cell 600 and a schematic detailed section 601 illustrating a joint between a first electrochemical cell member 603 and a second electrochemical member 604 shown. In embodiments, the first electrochemical cell member 603 which is a flat 100 μm thick anodic aluminum oxide membrane (AAO-membrane) based solid electrolyte (AAO-membrane based solid electrolyte 603) and the second electrochemical cell member 604 is an alpha-alumina frame (alpha-alumina frame 604). A cathode compartment 605 is bordered by the alpha-alumina frame 604, the AAO-membrane based solid electrolyte 603 and a cathode enclosure 606. An anode compartment 607 is bordered by the alpha-alumina frame 604, the AAO-membrane based solid electrolyte 603 and an anode enclosure 608. The connection between the AAO-membrane based solid electrolyte 603 and the alpha-alumina frame 604 is provided a joint 611 being of the form shown in FIGS. 3A-3B. The schematic detailed section 601 illustrates a cut 612, and two parallel joint segments 613, 614 forming the joint 611. The production of the joint 611 is described in FIG. 7 with reference to joint 711 where like elements have reference numerals indexed by one hundred.

Referring now to FIG. 7, a sodium nickel-chloride electrochemical cell 700 with an AAO-membrane based solid electrolyte 703, alpha-alumina frame 704, joint 711, and a cut 712 with joint segments 713, 714 is shown. The joint surface of the AAO-membrane based solid electrolyte 703 and the joint surface of the alpha-alumina frame 704 are brought in contact by positioning the AAO-membrane based solid electrolyte 703 and the alpha-alumina frame 704 into contact with each other. A desired position between the AAO-membrane based solid electrolyte 703 and the alpha-alumina frame 704 is maintained using a pressure pad 709 that applies a force on the AAO-membrane based solid electrolyte 703 in a direction towards the alpha-alumina frame 704 such that the AAO-membrane based solid electrolyte 703 remains in contact with the alpha-alumina frame 704 during formation of a the cut 712 within the AAO-membrane based solid electrolyte 703. One or more cut segments can be established with each cut segment having a cut segment length, a cut segment width and a cut segment line extending along the cut segment length and located approximately in the middle of the cut segment width. Also a cut stitch line is constituted by the cut segment lines joined together in a defined cutting sequence. A laser beam is focused on a cut segment and a laser beam spot is passed with a processing velocity of approximate 0.1 ms−1 to 0.5 m/s along the cut stitch line to establish cut segments and a continuous cut whereby the AAO-membrane based solid electrolyte 703 is laser-cut and a cut edge 715 is formed on the AAO-membrane based solid electrolyte 703. In embodiments, a laser welding system generates a pulsed wave laser beam having an emission wavelength of 1065 nm nm and a welding power of approximately 300 W to 500 W is used to produce the cut 712.

After a cut segment has been produced, the laser beam is focused on a joint segment of the joint 711. The laser beam spot is passed along the joint stitch line with a processing velocity of approximately between 0.1 m/s to 0.5 m/s to form a melt pool in the alpha-alumina frame 704. The laser beam, spot creates a melt pool at least partially within the alpha-alumina frame 704 and the melt pool of one or more joint segments, e.g. joint segments 713, 714, comes into contact with the cut edge 715 and forms the joint 711 between the AAO-membrane based solid electrolyte 703 and the alpha-alumina frame 704. In embodiments, a melt pool 716 from the joint segment 713 comes into contact with the cut edge 715 and a melt pool 717 from the joint segment 714 comes into contact with an oppositely disposed cut edge 719. The joint segment 713 and joint segment 714 can have an overlap along a joint segment length as discussed above with respect to FIGS. 2A-2B. The joint segment 713 can also have a lateral overlap with joint segment 714 as discussed above with respect to FIGS. 3A-3B.

It should be appreciated that the connection between the AAO-membrane based solid electrolyte 703 and the alpha-alumina frame 704 is produced within seconds, and the process energy consumption to form the connection is in the magnitude of watthours, even when considering the wall plug efficiency of the laser welding system. It should be also appreciated that the heat affected zone is in the range of millimeters and leaves most of the AAO-membrane based solid electrolyte 703 unaffected by the joining process. Particularly, the joining process does not lead to any degradation of the solid electrolyte by a diffusion caused alkali-metal loss.

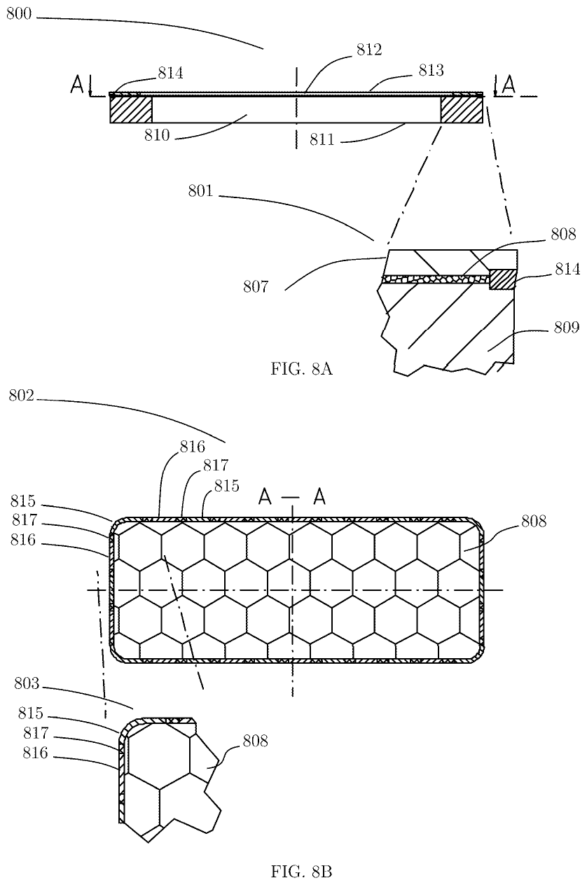

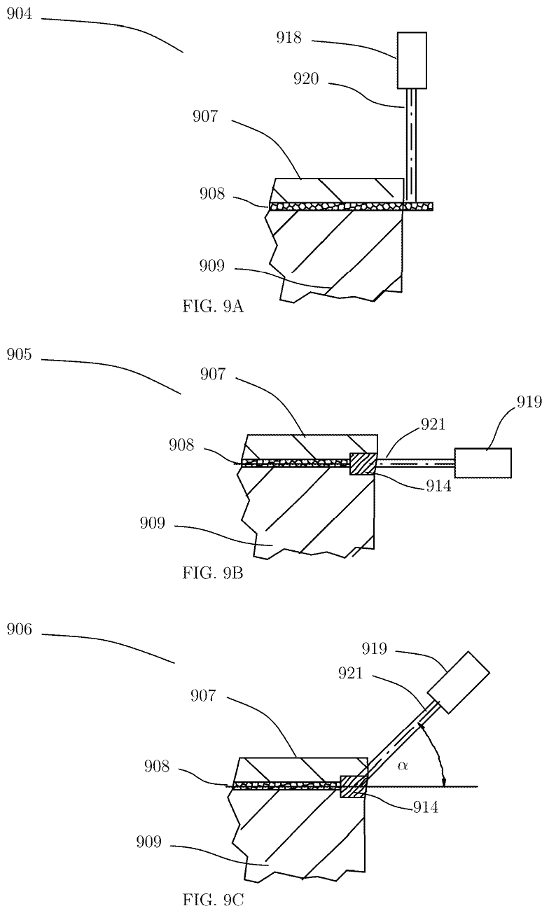

Referring now to FIGS. 8A-8B, a schematic cross section through a flat sodium nickel-chloride electrochemical cell 800 with a schematic detailed section 801 is shown. Specifically, FIG. 8A shows a cross sectional side view through a first electrochemical cell member 807, a second electrochemical cell member 808 and a third electrochemical cell member 809. In embodiments, the first electrochemical cell member 807 is a 250 μm thick anode-side alpha-alumina frame (anode-side alpha-alumina frame 807), the second electrochemical cell member 808 is a flat 100 μm thick AAO-membrane based solid electrolyte (AAO-membrane based solid electrolyte 808) and the third electrochemical cell member 809 is a cathode-side alpha-alumina frame (cathode-side alpha-alumina frame 809). A detailed view of the anode-side alpha-alumina frame 807, AAO-membrane based solid electrolyte 808, cathode-side alpha-alumina frame 809 and a joint 814 is shown generally at reference numeral 801. A cathode compartment 810 is bordered by the cathode-side alpha-alumina frame 809, the AAO-membrane based solid electrolyte 808 and a cathode enclosure 811. An anode compartment 812 is bordered by the anode-side alpha-alumina frame 807, the AAO-membrane based solid electrolyte 808 and an anode enclosure 813. A seal between the AAO-membrane based solid electrolyte 808, the anode-side alpha-alumina frame 807 and the cathode-side alpha-alumina frame 809 is provided by the joint 814, the joint 814 being of the form shown and discussed in FIGS. 2A-2B. FIG. 8B shows section A-A in FIG. 8A a reference numeral 802 and a detailed view of a corner section is shown generally at reference numeral 803. The detailed view 803 illustrates a joint segment overlap 817 between adjacent joining segments 815, 816. It should be appreciated that the order of producing the plurality of joint segments 815 and the plurality of joint segments 816 can be defined via one or patterns, sequences, etc. For example, in embodiments, all of the plurality of joint segments 815 are produced along the joint stitch line of the joint 814, and then all of the plurality of joint segments 816 are produced along the joint stitch line of the joint 814 with an overlap 817 present between adjacent joint segments 815, 816. In other embodiments, a single joint segment 815 is produced, followed by an adjacent joint segment 816 with an overlap 817 present between the adjacent joint segments 815, 816. The direction of the laser beam spot while producing a joint segment can also be defined via a clockwise and/or counterclockwise direction along a joint stitch line. In embodiments, the laser beam spot moves in a clockwise direction along the joint stitch line for each of the joint segments 815, 816. In other embodiments, the laser beam spot moves in a counter clockwise direction for each of the joint segments 815, 816. In still other embodiments, the laser beam spot moves in a clockwise direction for the joint segments 815 and moves in a counter clockwise direction for the joint segments 816, or vice versa. The production of the joint 814 is described in FIGS. 9A-9C with reference to joint 914 where like elements have reference numerals indexed by one hundred.

Referring now to FIGS. 9A-9C, an anode side alpha-alumina frame 907, AAO-membrane based solid electrolyte 908, cathode side alpha-alumina frame 909, and joint 914 are shown. In FIG. 9A, the joint surface of the AAO-membrane based solid electrolyte 908 and the joint surface of the cathode side alpha-alumina frame 909 are brought in contact by positioning the AAO-membrane based solid electrolyte 908 and the cathode side alpha-alumina frame 909 into contact with each other. The opposite sided joint surface of the AAO-membrane based solid electrolyte 908 and the joint surface of the anode side alpha-alumina frame 907 are brought in contact by positioning the AAO-membrane based solid electrolyte 908 and the cathode side alpha-alumina frame 909 into contact with each other. The AAO-membrane based solid electrolyte 908 located and sandwiched between the anode side alpha-alumina frame 907 and the cathode side alpha-alumina frame 909. A laser 918 generates a laser beam 920 which is generally to the AAO-membrane based solid electrolyte 908. The laser beam trims the AAO-membrane based solid electrolyte 908 extending beyond the anode side alpha-alumina frame 907 and/or cathode side alpha-alumina frame 909 and a generally continuous edge is formed in the area where the joint 914 is to be formed.

Referring to FIG. 9B, a detailed section 905 illustrates a joining process between the AAO-membrane based solid electrolyte 908, the anode side alpha-alumina frame 907 and the cathode side alpha-alumina frame 909. A laser 919 generates a laser beam 921 generally parallel with the median longitudinal plane of the AAO-membrane based solid electrolyte 908 and is focused and produces a laser beam spot at the location where the AAO-membrane based solid electrolyte 908 is sandwiched between the anode side alpha-alumina frame 907 and the cathode side alpha-alumina frame 909. The laser beam spot moves along a joint stitch line with a processing velocity of approximate 0.1 m/s to 0.5 m/s to form a melt pool and produce a gastight joint 914 between the AAO-membrane based solid electrolyte 908, the anode side alpha-alumina frame 907 and the cathode side alpha-alumina frame 909.

Referring to FIG. 9C, a detailed section 906 illustrates another embodiment of the joining process between the AAO-membrane based solid electrolyte 908, the anode side alpha-alumina frame 907 and the cathode side alpha-alumina frame 909. Specifically, the laser 919 generates the laser beam 921 at an angle α relative to the median longitudinal plane of the AAO-membrane based solid electrolyte 908. The laser beam is focused and produces a laser beam spot at the location where the AAO-membrane based solid electrolyte 908 is sandwiched between the anode side alpha-alumina frame 907 and the cathode side alpha-alumina frame 909. The laser beam spot moves along the joint stitch line with a processing velocity of approximate 0.1 m/s to 0.5 m/s to form a melt pool and produce a gastight joint 914 between the AAO-membrane based solid electrolyte 908, the anode side alpha-alumina frame 907 and the cathode side alpha-alumina frame 909.

In embodiments, laser welding system generating a pulsed wave laser beam having an emission wavelength of 1065 nm nm and a welding power of approximately 300 W to 500 W is used. It should be appreciated that the connection between AAO-membrane based solid electrolyte 908, the anode side alpha-alumina frame 907 and the cathode side alpha-alumina frame 909 is produced within seconds, and the process energy consumption to form the connection is in the magnitude of watthours, even when considering the wall plug efficiency of the laser welding system. It should be also appreciated that the heat affected zone is in the range of millimeters, and most, if not nearly all, of the AAO-membrane based solid electrolyte 908 is unaffected by the joining process. In particular, the joining process does not lead to any degradation of the solid electrolyte by a diffusion caused alkali-metal loss.

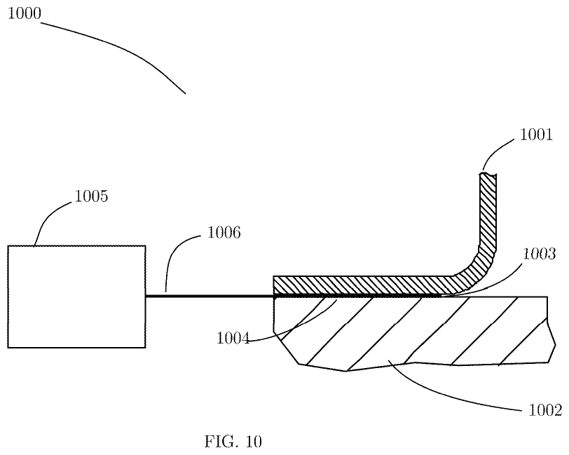

Turning now to FIG. 10, a schematic cross section of a first electrochemical cell member 1001, a second electrochemical cell member 1002 and a brazing filler material 1003 between the first electrochemical cell member 1001 and the second electrochemical cell member 1002 is shown generally at reference numeral 1000. In embodiments, the first electrochemical cell member 1001 is an electrode housing (electrode housing 1001) and the second electrochemical cell member 1002 is an alpha-alumina member (alpha-alumina member 1002). A connection or seal between the electrode housing 1001 and the alpha-alumina member 1002 is produced in an embodiment process of the current disclosure in the following steps.

The brazing filler material 1003 is applied on a joint surface of the alpha-alumina member 1002 and the joint surface of the electrode housing 1001 and the joint surface of the alpha-alumina member 1002 are brought in contact by positioning the electrode housing 1001 and the alpha-alumina member 1002 into contact with each other. A laser system 1005 produces a laser beam 1006 with a laser beam spot focused on the brazing filler material 1003 that is between the joint surface of the electrode housing 1001 and the joint surface of the alpha-alumina member 1002. The laser beam spot moves with a processing velocity of approximate 50 m/min along a joint stitch line, the temperature of one or more joint segments is raised above a melting temperature of the brazing filler material 1003 and a gastight joint is produced between the electrode housing 1001 and the alpha-alumina member 1002. The joining process is a brazing process utilizing the laser system 1005 generating the laser beam 1006, e.g. a continuous laser beam having an emission wavelength of 1065 nm and a power of approximately 400 W to 500 W.

It should be appreciated that the connection between the electrode housing 1001 and the alpha-alumina member 1002 is produced within seconds, and the process energy consumption to form the connection is in the magnitude of watthours, even when considering the wall plug efficiency of the laser welding system.

It is noted that the term “generally” may be utilized herein to represent the inherent degree of uncertainty that may be attributed to any quantitative comparison, value, measurement, or other representation. This term is also utilized herein to represent the degree by which a quantitative representation may vary from a stated reference without resulting in a change in the basic function of the subject matter at issue.

While the disclosure has been described with reference to certain specific embodiments and examples, it will be recognized by those skilled in the art that many variations are possible without departing from the scope and spirit thereof. As such, it is the claims, and the equivalents thereof, that define the scope of the disclosure.

1. A method for laser joining a first electrochemical cell member to a second electrochemical cell member, the method comprising:
a) providing the first electrochemical cell member comprising an inorganic material, the first electrochemical cell member having a first thickness and a first joint surface;
b) providing the second electrochemical cell member comprising an inorganic material, the second electrochemical cell member having a second thickness and a second joint surface;
c) defining:
c1) placement of at least two joint segments, each joint segment having a joint segment length, a joint segment width and a joint segment line extending along the joint segment length and generally in the middle of the joint segment width;
c2) placement of a joint made from the at least two joint segments, with adjacent joint segments in contact to each other;
c3) a joint sequence;
c4) a joint stitch line made by the at least two joint segment assembled in the joint sequence;
d) establishing contact between the first joint surface and the second joint surface by positioning the first electrochemical cell member and the second electrochemical cell member relative to each other;
e) producing a laser beam using a laser system, the laser beam having a laser beam spot focusing on the joint stitch line; and
f) passing the laser beam spot along the joint stitch line to establish the at least two joint segments, the at least two joint segments forming a connection between the first electrochemical cell member and the second electrochemical cell member.

2. A method according to claim 1, wherein step (f) comprises the steps of:
f1-c) defining the placement of a continuous cut congruent with the placement of the joint, the continuous cut made from at least two cut segments with adjacent cut segments in contact to each other, each cut segment placement having a cut segment length, a cut segment width and a cut segment line extending along the cut segment length and located generally in the middle of the cut segment width, a cutting sequence, and a cut stitch line made by the at least two cut segment lines assembled together in the cutting sequence;
f2-c) passing the laser beam spot along the cut stitch line to establish the at least two cut segments and the continuous cut, whereby the first electrochemical cell member is laser-cut and a cutting edge is formed in the first electrochemical cell member.

3. A method according to claim 1, wherein step (d) further includes d1-b) applying an additional joining material at least on one of the first joint surface or the second joint surface prior to bringing the first joint surface and the second joint surface in contact to each other.

4. A method according to claim 2, wherein (f) further includes f1-b) raising a temperature of the joint segments above a melting temperature of the additional joining material by passing the laser beam spot along the joint stitch line.

5. A method according to claim 1, wherein at least one of the inorganic material of the first electrochemical cell member and the inorganic material of the second electrochemical cell member comprises a glass or ceramic material.

5. A method according to claim 1, wherein the first electrochemical cell member is a solid electrolyte or separator.

6. A method according to claim 1, wherein the second electrochemical cell member comprises an electrically non-conductive material.

7. A method according to claim 1, wherein the connection between the first electrochemical cell member and the second electrochemical cell member is a gastight connection.

8. A method according to claim 1, wherein the first electrochemical cell member is a solid electrolyte or separator comprising an inorganic material preferably a glass or a ceramic material; and the second electrochemical cell member is an inorganic electrically non-conductive material, preferably a glass or a ceramic material.

9. A method according to claim 3, wherein the additional joining material comprises a seal glass, a soldering filler material, a brazing filler material, or an adhesive.

10. A method according to claim 1, wherein at least one of the inorganic material of the first electrochemical cell member and the inorganic material of the second electrochemical cell member comprises a glass or a ceramic material.

11. A method according to claim 1, wherein the first electrochemical cell member is a solid electrolyte or separator.

12. A method according to claim 1, wherein the second electrochemical cell member comprises an electrically non-conductive material.

13. A method according to claim 1, wherein the first electrochemical cell member comprises an electrically conductive material.

14. A method according to claim 1, wherein the first electrochemical cell member comprises a metal.
